(19) United States
(12) Patent Application Publication
(10) Pub. No.: US 2003/0033319 A1
(43) Pub. Date: Feb. 13, 2003

(54) Entry of physical documents in a digital back-end system

(76) Inventors: Erwin Adrianus Richards Van Der, Venlo (NL); Peter Franciscus Marie Nacken, St. Michielsgestel (NL)

Correspondence Address: BIRCH STEWART KOLASCH & BIRCH, PO BOX 747, FALLS CHURCH, VA, 22040-0747, US

(21) Appl. No.: 10/214,153

(22) Filed: Aug. 8, 2002

(30) Foreign Application Priority Data
Aug. 8, 2001 (EP) 01203006.0

(51) Int. Cl. G06F 7/00

(52) U.S. Cl. 707/102

(57) ABSTRACT

A method, system and computer program product for entering physical documents into a digital back-end system are provided. The system includes at least one scanner for scanning a document and generating an associated document image file, a server including an intermediate document store, connected to the scanner for storing a document image file together with a document identification in a document file, and at least one input device connected to the server for entering an attribute file. The attributable file contains a set of document attributes accompanied by a document identification. The server includes a merging unit for checking whether a document identification of one of the attribute files corresponds to a document identification of one of the document files and, if so, the merger unit links the set of attributes to this document file.

The present application claims, under 35 U.S.C. §119, the priority benefit based on European Patent Application No. 01203006.0 filed Aug. 8, 2001.

### BACKGROUND OF THE INVENTION

1. Field of the Invention

The invention relates to a method and system for entering physical documents into a digital back-end system, wherein the scanning of the documents and entry of the associated document attributes are not limited to a specific place and/or time.

2. Discussion of the Related Art

A back-end system into which physical documents are entered in electronic forms is known to include a filing, archiving or document management system or a workflow system or a document reproduction system. For instance, such a system may include one or more mass memory devices for storing digital images of a large number of documents. Each document has a number of attributes which may, for example, describe the contents or the type or category of the document so as to facilitate the search and retrieval process, or which may control the further processing of the document (e.g., online or hard-copy distribution to various destinations, printing, and the like).

Conventionally, the attributes of a document are entered into a system at the same time and place as the document itself is scanned-in, so that the attributes can be directly allocated to the scanned document data. This can be inconvenient since it requires availability and entry of both the document itself and the document attribute information at the same time and place. However, both the document and attributes may not be available or cannot be entered at the same time and place due to different circumstances. Further, the document attributes may change while the document itself remains the same, or vice versa. In such cases, the conventional systems may require entry of both the document and document attributes again to update the system. This is inefficient and time consuming. Thus, the inflexibility of conventional document entry systems and methods is unsuitable to accommodate situations where multiple parties and documents are involved at different places and/or times with modification needs.

On the other hand, according to a related art, U.S. Pat. No. 4,970,554 discloses a method for printing documents, in which job tickets for a plurality of print jobs or documents can be prepared by a client at his own workstation. Each job ticket includes the printing instructions for the job in machine readable form and a job number identifying the job. The job tickets are stored in a job program file, and hard copies of the job tickets, on which the job numbers are encoded in machine readable form, are printed with a local printer. The hard copies of the job tickets are then combined with the respectively associated documents and are delivered to a reproduction center together with these documents. In the reproduction center, the document originals and the job tickets associated therewith are scanned, and the job numbers are used for retrieving the printing instructions for each job from the job program file, so that each job can be printed in accordance with the printing instructions. When the job has been printed, the printing instructions are either deleted or stored for the purpose of preparing a new job ticket with a new job number.

### SUMMARY OF THE INVENTION

Accordingly, it is an object of the invention to provide a method and system for entering documents into a back-end system, which offer more flexibility in the process of scanning documents and entering attributes for entry into a back-end system.

It is another object of the invention to provide a method and system for entering documents into a back-end system, which overcome problems and disadvantages associated with the related art.

According to the invention, these and other objects are achieved by a method for entering documents into a back-end system, including the steps of: (a) generating a unique document identification for a document to be processed; (b) when the document is scanned, storing the associated document image file together with the document identification into an intermediate digital document store; (c) when the attributes for the document are entered, storing the same together with the document identification into the intermediate digital document store; and (d) checking for coincidence of the document identifications stored in the steps (b) and (c) and consolidating a document and attributes having the same document identification in the intermediate digital document store.

The method according to the invention has the advantage that the step (b) in which the documents are scanned, which requires that the document originals are physically present at the scanner, and the step (c), in which the attributes are entered, can be fully uncoupled not only in space but also in time. This makes it very convenient for users to submit their documents to the system.

The invention is not limited to a certain time sequence of the steps (b) and (c). Thus, for example, a client may define a number of sets of attributes for a plurality of documents at his local workstation and may submit them online to the system and may then choose to bring or send the document originals to the scanner at a later time, whenever he finds it convenient to do so. If the document attributes include or are accompanied by instructions or parameters relating to the scan process or to a subsequent printing operation to be performed in a reproduction center, then this course of action may also have the advantage that the job scheduling task is facilitated for the operator in the reproduction center, because the instructions are available earlier. In an archiving application, it may also be regarded as an advantage that the attributes are searchable already in the intermediate document store even before the document has actually been scanned in.

When a client submits only a scan job or a copy job in which the printing of the copies is not urgent, the operator may for example decide to give priority to more urgent scan jobs and to keep the document originals of the less urgent jobs in the reproduction center until a scanner becomes available for handling the jobs. In a print-on-demand scenario, the operator may even postpone the scanning of the originals until a first print order occurs.

Conversely, the user may prefer to have the documents scanned first and to enter the associated attributes later.

It is possible that the document identification is generated and assigned automatically at the time of scanning, i.e., the steps (a) and (b) above are performed almost concurrently, or that the document identification is generated and assigned automatically at the time when the attributes are entered, i.e., the steps (a) and (c) are performed almost concurrently. The identification that has been assigned to the document is then displayed or printed or notified to the user in any other suitable way, so that the user may refer to this identification when he has the document scanned or when he enters the attributes.

If a system for entering documents into a back-end system according to an embodiment of the present invention includes a plurality of scanners, which may be disposed at different locations, provisions have to be made to assure uniqueness of the automatically assigned document identifications. This may be achieved, for example, by interconnecting the scanners through a network or by using an identification format which includes the time and place where the document is scanned.

The requirement that the document identification is “unique” has the purpose to ensure that the documents and attributes are always combined in the correct way. When the step (d) above has been performed for a pair of document and attributes having a matching identification, it would, in principle, be possible to delete the identification from the combined record, so that the same identification could be assigned to a new set of attributes or a newly scanned document. In this sense, a temporary uniqueness of the identification is sufficient. In many cases, it will however be preferable to require absolute uniqueness and to retain the identification as a unique key field or identifier for the records.

A system for entering documents into a back-end system according to the invention is provided with a server including a merging unit which will be called herein as “Merger” for performing the step (d) in the method discussed above. This Merger may be formed by a software module running on a server of the back-end system or may be formed by a separate server component connected to the back-end system. Preferably, the Merger has its own storage facilities for temporarily storing the scanned document data and the sets of attributes until they are combined with each other and sent to the back-end system, e.g., for permanent storage.

The system for entering the documents into the back-end system according to an embodiment of the present invention further includes one or more input devices allowing the users to enter the sets of attributes for their documents. Some of these input devices may be installed at the locations of the scanners, so that the users may enter the attributes when the documents are scanned-in. In a particularly preferred embodiment, however, most or all of the input devices are formed by client computers which are connected to the document store through a network system such as the Internet, an intranet or an extranet. Then, the Merger preferably operates as a network server which responds to a request transmitted from a client by electronically transmitting a submission form description to the client. The submission form description is a piece of program code (e.g., HTML) which is interpreted in the client computer (e.g., by a web browser), so that a corresponding submission form according to the submission form description is displayed on the screen or other display unit of the client computer. The client user may then fill in the submission form by entering the document attributes and possibly other information and instructions and may retransmit the completed submission form to the Merger via the network according to existing network transmission techniques.

The submission form also includes the document identification which may have been assigned automatically by the Merger or may be entered by the user in a format which guaranties uniqueness. A possible format of the document identification may be: <user ID><date><running number>. The user may also print a copy of the submission form and may attach it to the stack of document originals to be supplied to the scanner.

According to one embodiment, if the document originals have been scanned already before the attributes are submitted, the user may indicate his personal user ID, for example, in his request for transmission of the submission form description. The Merger will then automatically search its local store for document identifications including this user ID and will list all scanned documents of this user in the submission form, for example, in the form of reduced copies (thumb nails) of a first page of each document. The client user can then select the document identification of the document for which he wants to submit the attributes simply by clicking onto the corresponding thumb nail.

The invention is applicable for example for decentralized or central entry of paper documents into a document store (e.g., filing, archiving or document management system).

The decentralized system has several attached document scanners (possibly multi-functional devices for scanning, printing and copying). These scanners may be placed at different locations in an office environment. If an office worker wants to enter a paper document in the document store, he walks to the closest document scanner (or multi-functional device) and enters his document. On the other hand, any document attribute entry can be carried out using a PC at his desk. As a result, there is no longer a need to physically bring paper documents to a central “archiving” department for storage purposes.

Another possible application of the present invention is the submission of reproduction jobs to a reproduction center. Again, the invention can be used both centrally and decentralized. In the last situation there is no longer a need to physically bring a paper document that should be reproduced to the reproduction department. The document is scanned at the nearest document scanner (or multi-functional device) using one of the described methods. In this application the document attributes may represent both administrative data about the reproduction order and print and finishing options. In this case, the invention is particularly useful in combination with an online submission system for print jobs as has been described in European Patent Application No. 1 132 808.

The invention can further be used to distribute scanned documents to any number of recipients. In this case, the document attributes represent the “addresses” (e.g., e-mail addresses or fax numbers) of the recipients.

In banking and insurance companies, often workflow systems are in place. These systems often have a need for paper document entry. The invention can be used as a front-end for these workflow systems, enabling centralized or decentralized entry of paper documents with their attributes.

The invention is also related to a computer program product comprising computer program code(s) for implementing the server that includes the Merger, and to a computer program product comprising the program element stored on a computer-readable medium. Any know computer programming language may be used to implement the present invention. A back-end system can be any system, network, device, medium, or entity that needs or uses the scanned document data and the associated attributes. The term “document” is used to also cover any scannable entity having associated attributes.

### BRIEF DESCRIPTION OF THE DRAWINGS

Preferred embodiments of the invention will now be described in conjunction with the drawings, in which:

FIG. 1 is a block diagram of a system for entering documents into a back-end system according to an embodiment of the present invention;

FIG. 2 is a flow chart illustrating a method for entering documents into a back-end system according to an embodiment of the present invention;

FIG. 3 is a flow chart illustrating a modification of the method shown in FIG. 2 according to another embodiment of the present invention;

FIG. 4 is a screen shot of one example of a submission form for entering document attributes, which is usable in the present invention;

FIG. 5 is a screen shot of another example of a submission form for entering document attributes, which is usable in the present invention; and

FIG. 6 is a screen shot of an example of a submission form for entering print specifications for a document, which is usable in the present invention.

### DETAILED DESCRIPTION OF THE PREFERRED EMBODIMENTS

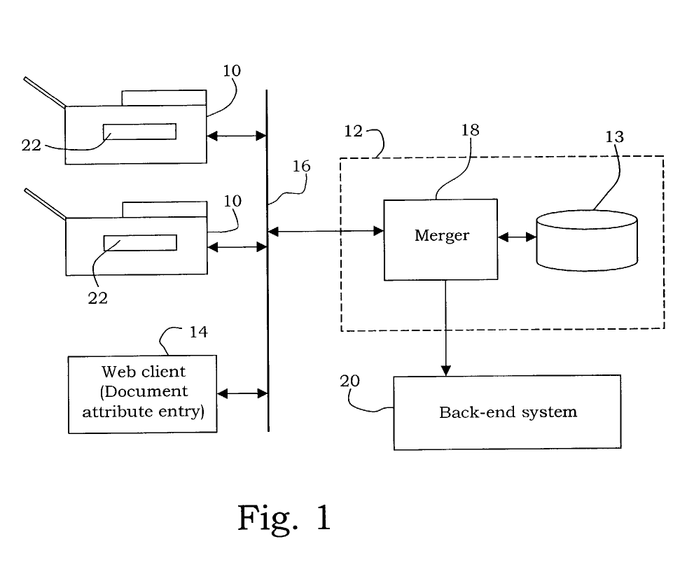

FIG. 1 shows a possible schematic set-up of a system for entering documents into a back-end system according to an embodiment of the present invention. As shown in FIG. 1, the system includes one or more document scanners 10, a server 12, and one or more client computers 14 connected to the server 12 through a network 16, e.g., an intranet or extranet. The server 12 comprises a component that is called “Merger” 18 and a storage device 13 for intermediate storage of document image files and/or attribute files. The server 12 is connected to at least one back-end system 20 such as, for example, an archiving system, a workflow system of a company or the like.

In a centralized set-up, the scanner or scanners 10 will be installed at the location of the server 12 and may be connected to the Merger 18 by wirelines, although network connections are increasingly used also for short-range connections. In a decentralized set up, the scanners 10 will be installed at remote locations, e.g., closer to the work places of office workers using the system. Then, the scanners 10 are connected to the Merger 18 through the network 16 or through a separate network. Each scanner 10 has an operating console 22 providing a facility to associate a (temporarily) unique document identification (ID) with each scanned document. In this process, the scanning process discussed in European Patent Application Publication EP-A-1 096 775 may be used. The entered ID may for instance become a part of the filename of the document image file.

The client computers 14 serve as input devices for entering document attributes for the documents to be scanned or already scanned. It may be that these client computers 14 are workstations or personal computers which are located at the various work places of the users and on which a client application for entering the document attributes has been installed. It will be understood that such an application may be a web-client, but may also be any other type of client application which may be used as an input device. Such input devices may be installed at the locations of the scanners 10 or may be integrated in multi-functional devices including a scan function.

The Merger 18 has the following functions:

It provides a submission form description, i.e., a program code (in case of a web-client this will typically be HTML) to generate a document attribute entry form on the client computer 14;

It receives and temporarily stores document image files from the scanners 10;

It receives and temporarily stores document attributes received from the client computers 14; and

It consolidates document attributes and document image files having the same document ID and sends them, through an appropriate interface, to the connected back-end system 20.

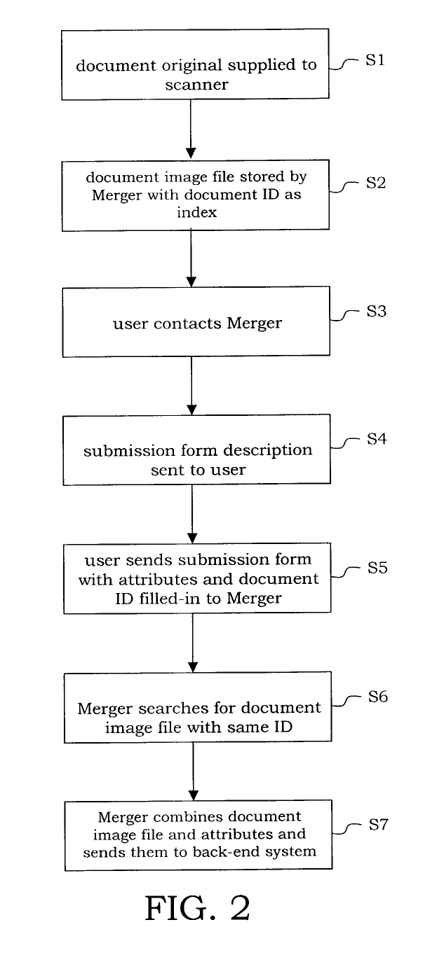

An example of a possible workflow according to an embodiment of the present invention is illustrated is FIG. 2. This workflow may be implemented in the system of FIG. 1 or in any other suitable system.

Step S1 of FIG. 2: A paper document is scanned using any of the document scanners 10 connected to the system. Before or after the actual scanning process, a document ID is entered at the corresponding console 22 of the document scanner 10. This document ID must be unique, even if it is for temporarily, to ensure accurate matching of the document to the attributes. A possible format for the document ID could be, e.g., <user ID><date><running number>, but other formats may be used. It must be remembered by the scan operator which document ID was used for which particular paper document.

Optionally, the document ID or at least a part thereof may be generated automatically in the scanner 10 or in the Merger 18 communicating therewith. For example, it may be sufficient for the user to enter his user ID, and the document ID is generated automatically by adding the current date and a running number to the received user ID. The generated document ID will then be displayed on the corresponding console 22, so that the scan operator or the user may note the document ID.

Step S2: The document image file, along with the document ID, is transferred to the Merger 18, where it will be temporarily stored in the intermediate storage device 13 under control of the Merger 18. The document ID is used as an index for the document image file.

Step S3: Any time later, at any place where a client computer 14 is available, the user may start a procedure (steps S3 to S5) for entering the document attributes belonging to an earlier scanned document. To this end, the user sends a request for an attribute submission form to the URL (Universal Resource Locator) of the Merger 18 at a client computer 14 via the network 16.

Step S4: The Merger 18 responds to this request by sending a submission form description to the client computer 14 from which the request had been sent, via the network 16. This submission form description is a piece of software that is interpreted by the browser software in the client computer 14 to generate, on the screen or display unit of the client computer, a submission form or attribute entry form in which the user may fill in the document attributes along with the corresponding document ID that has been memorized or noted in Step S1.

Step S5: When the required data on the submission form have been filled in and the user clicks a “submit” button on the submission form or performs other designated action to transmit the filled-in data, the submission form including the document attributes and the document ID will automatically be transmitted to the Merger 18 via known transmission techniques.

Step S6: The Merger 18 receives the attributes and checks whether a document image file having the same document ID is available in the intermediate storage device 13. Obviously, the attributes themselves may be temporarily stored in the storage device 13 as well.

Step S7: If the document image file having the identified document ID (associated with the received attributes) is found, the document image file and the document attributes corresponding to the identified document ID are automatically consolidated by the Merger 18 and entered into the back-end system 20. The document image file and the associated attributes may also be stored in the storage device 13 for any use by the Merger 18 or other components of the system.

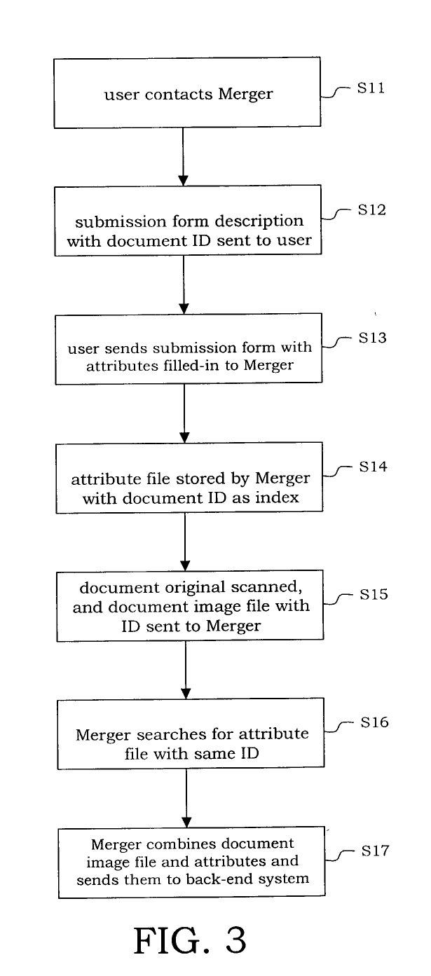

FIG. 3 illustrates an alternative workflow according to another embodiment of the present invention. This workflow is also implementable in the system of FIG. 1 described above. In this embodiment, document attributes are entered first for a paper document that has not been scanned yet.

Step S11 of FIG. 3: As in step S3 above, a request for an attribute submission form is sent from a client computer 14 to the Merger 18, e.g., via the network 16.

Step S12: The submission form description is sent form the Merger 18 to the client computer 14. This submission form description may already include a unique document ID that has automatically been generated by the Merger 18. This document ID may be based on the user ID which has been transmitted together with the request for an attribute submission in step S11 or which the user has been invited to enter in a separate query.

Step S13: The user fills in the document attributes and sends the attribute submission form to the Merger 18. If the document ID has not been generated automatically, it must be entered manually, e.g., in the format <user ID><date><running number> which guarantees uniqueness. In any case, it must be remembered which document ID was used for which particular paper document. For this reason the entry form with document attributes and document ID may be printed and attached to the paper document for the user. As an alternative, a sticky note bearing the document ID may be attached to the paper document.

Step S14: The document attributes are temporarily stored in the storage device 13 associated with the Merger 18. The document ID is used as an index for the document attributes.

Step S15: Any time later, the associated paper document is scanned using any of the scanners 10 of the system. Before or after the actual scanning process, the matching document ID identifying the document that is to be scanned or has been scanned, is entered at the console 22 of the client computer 14. The scanned document image file, along with the document ID, will then be transferred to the Merger 18 using known transmission techniques.

Step S16: The Merger 18 receives the document image file, stores it in the intermediate storage device 13 (e.g., using the document ID as an index) and searches for document attributes that have the same document ID as the received document image file, from all the attribute files stored in the storage device 13.

Step S17: If an attribute file with the matching document ID is found, the received document image file and the located document attributes are automatically consolidated by the Merger 18 (e.g., using the document ID as an index) and entered into the back-end system 20.

In the second workflow of FIG. 3, the entered document attributes along with a barcode version of the document ID could be printed on a sheet of paper and attached to the paper document as a banner page. As an alternative for the manual entry of the document ID in step S15, the banner page could be scanned along with the actual document, and bar-code recognition could be applied, for instance, in the Merger 18, to retrieve the document ID. In other examples, other machine-readable codes may be used in lieu of barcodes.

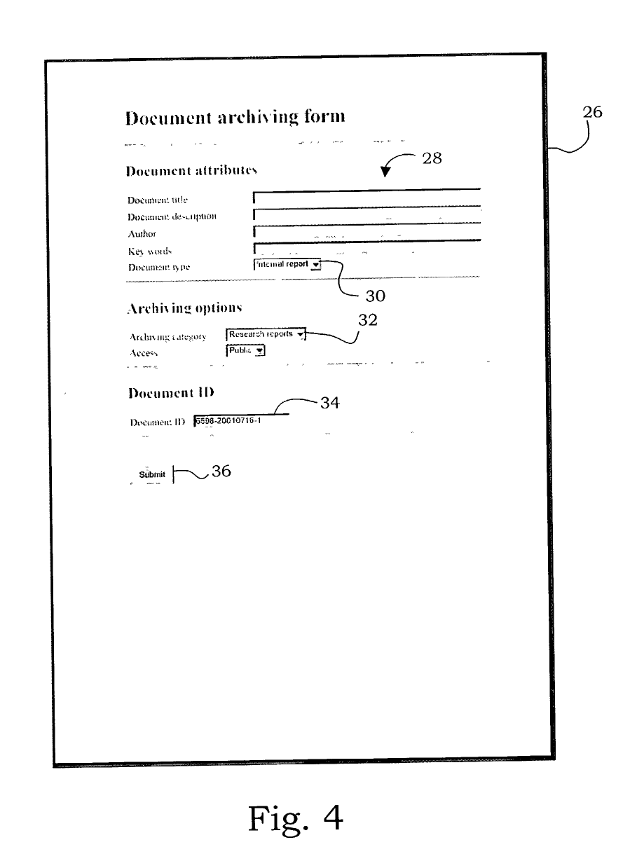

FIG. 4 shows a document archiving form as a first example of an attribute submission form 26 to be filled-in by the user, which may be used in the present invention. Referring to FIG. 4, this form includes any number of fields 28 in which the user has to enter various types of document attributes such as the document title, a brief document description, the name of the author, a selection of key words, etc. A pull-down menu 30 permits to specify one of a number of predefined document types such as “internal report”. Other pull-down menus 32 permit to select between predefined archiving options relating to the archiving category (e.g., research reports, newspaper articles, and the like) as well as the access type (public, restricted, . . . ). Thus, the fields 28 and menus 30 and 32 are used to enter document attributes.

The document ID has to be entered either automatically or manually in a field 34. In the example shown, the document ID is composed of a combination of a user ID (“6598”), the current date (Jul. 16, 2001), and a running number (“1”). A running number can be a random number or a sequenced number.

A submit-button 36 becomes active when all necessary information (especially the document ID) has been entered, and permits to send the submission form to the Merger 18 as discussed above.

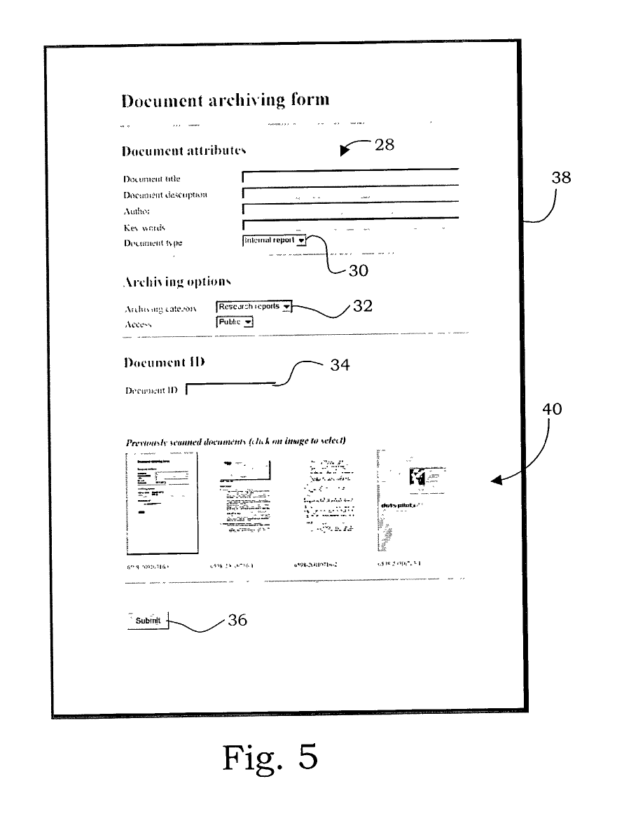

FIG. 5 shows another example of an attribute submission form 38 usable in the present invention, which is again a document archiving form. In addition to the items discussed above in connection with FIG. 4, this form further includes a list 40 of previously scanned documents of the same user. Each of these documents is represented by a reduced copy (thumb nail) of the front page and by the associated document ID.

The submission form 38 is intended for the workflow illustrated in FIG. 3. It is assumed here that step S11 has the form of a logon procedure in which the user is asked to identity himself by his user ID. This user ID then permits the Merger 18 to search for all documents of this user that have been scanned previously and are still temporarily stored in the Merger 18 or the storage device 13. These documents will then be included in the list 40 as part of the form 38. In order to indicate the document to which the attributes entered in the fields 28 or the like belong, the user simply clicks on one of the thumbnails in the list 40, and the selected document ID will automatically be entered into the field 34. Obviously, other known schemes may be used to provide a list of document IDs for the user's quick selection and entry.

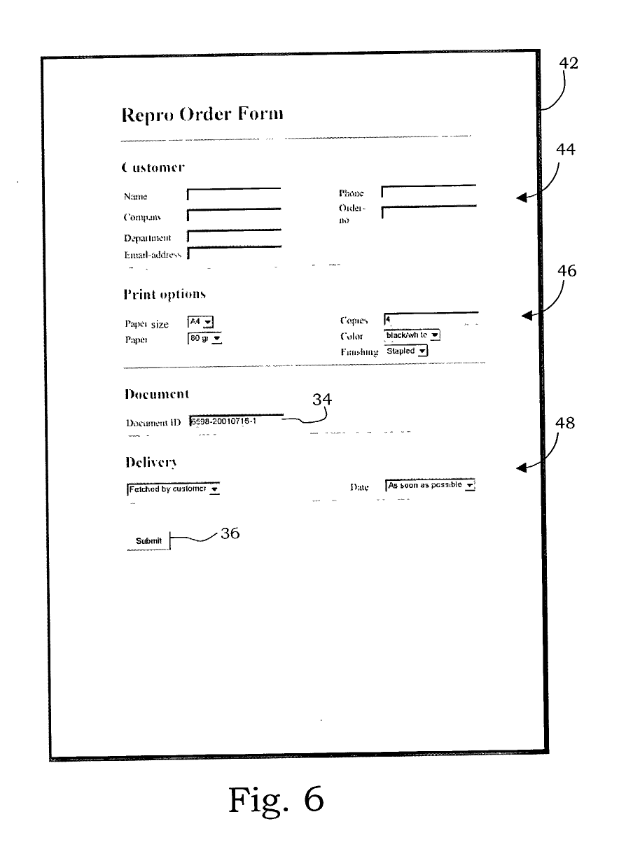

FIG. 6 shows a reproduction order form as another example of an attribute submission form 42 usable in the present invention. Here, the document attributes includes a set of data 44 relating to the customer, e.g., the owner of the document, and a set of data 46 specifying the way in which the document is to be printed. Other attribute data 48 relate to the desired delivery mode (e.g., “fetched by customer”) and the scheduled time (e.g., “as soon as possible”) for the delivery of the printed copies. Obviously, other types of attribute entries may be provided in the form 42.

It will be understood that the form 42 may also include a list of previously scanned documents corresponding to the list 40 in FIG. 5.

In the present invention, any other kinds of attributes may be contemplated for connecting to the document and entering in an attribute submission form. The embodiments of attribute submission forms given here are intended for explanatory purposes only and the present invention is not limited to such examples only.

If a number of different types of attribute submission forms, such as the forms 26, 38 and 42, are available in the Merger 18, the user may indicate the required type of form in his request (step S3 or S11) or in the logon procedure.

Although the invention has been described with reference to the above exemplified embodiments, it will be clear to the skilled person that other embodiments are possible within the text of the claims. They are considered to be within the scope of protection of this patent.

1. A method for entering physical documents into a digital back-end system, the method comprising the steps of:
scanning a physical document in a scanner and generating an associated document image file;
inputting attributes associated with the document; and
storing the document image file together with its associated attributes,
wherein these steps include steps of:
b) when the document is scanned, storing the associated document image file together with a unique document identification into an intermediate digital document store,
c) when the attributes for the document are entered, storing these attributes together with the same unique document identification into the intermediate digital document store, and
d) checking for coincidence of the document identifications stored in steps (b) and (c) and consolidating a document and attributes having the same document identification in the intermediate digital document store.

2. The method according to claim 1, wherein the step (c) is performed later than the step (b).

3. The method according to claim 1, wherein the step (b) is performed later than the step (c).

4. The method according to claim 1, further comprising the step of:
a) automatically generating a unique document identification for a document to be processed in reaction to initiation of one of the steps (b) and (c), whichever is performed first, and reporting said unique document identification to a device performing said first performed step of the steps (b) and (c).

5. The method according to claim 1, wherein the attributes and the associated document identification are transmitted to the intermediate digital document store through a network.

6. The method according to claim 1, wherein the step (c) includes an electronic transmission of a submission form description to a client, said submission form description being a program code that is interpreted on the side of the client to electronically create a submission form capable of being filled-in electronically by the client and allowing the client to interact with the intermediate document store by entering information, including the attributes, into the submission form.

7. The method according to claim 6, wherein the document identification includes a user identification and, when a user identified by the user identification requests a transmission of the submission form description, the intermediate document store is searched for previously scanned documents of this user, and a list of these documents is included in the submission form.

8. A system for entering physical documents into a digital back-end system, comprising:
at least one scanner for scanning a document and generating an associated document image file;
a server including an intermediate document store, connected to the scanner, for storing a document image file together with a document identification; and
at least one input device, connected to the server, for entering an attribute file which includes a set of document attributes accompanied by a document identification,
wherein the server includes a merging unit for checking whether a document identification of an attribute file corresponds to a document identification of a document file and, if so, links said attribute file to said document file.

9. The system according to claim 8, wherein the scanner comprises input means for entering a document identification to be included in a document file.

10. The system according to claim 8, wherein the server is connected to a back-end system and wherein the merging unit is arranged to temporarily store the document files and the attribute files, each accompanied by their associated document identification, into the intermediate document store until these files are consolidated and then the merging unit sends the consolidated file to the backend system.

11. The system according to claim 10, wherein the server is arranged for automatically creating a document identification and assigning it to an attribute file when the attributes of the attribute file are entered earlier than a corresponding document file.

12. The system according to claim 10, wherein the server is arranged for automatically creating a document identification and assigning it to the document file when the document file is entered earlier than a corresponding attribute file.

13. The system according to claim 11, wherein the server is arranged for reporting back the created document identification to the scanner.

14. The system according to claim 12, wherein the server is arranged for reporting back the created document identification to the input device.

15. The system according to claim 8, wherein the server is arranged for generating a digital submission form description and sending it to a client upon request, said submission form description being a program code that is interpreted on the side of the client to create a submission form capable of being filled-in electronically by the client and allowing the client to interact with the intermediate document store by entering information, including the attributes, into the submission form.

16. The system according to claim 15, wherein the document identification includes a user identification and wherein the server is arranged to, in reaction to a user identified by the user identification and requesting a transmission of the submission form description, search the intermediate document store for previously scanned documents of this user, and include a list of the located documents in the submission form.

17. The system according to claim 8, wherein said at least one scanner and said at least one input device are configured to communicate with the server through a network.

18. A device usable in a system for entering documents into a digital back-end system, the device comprising:
a merger receiving a document identification with either a document image file or a document attribute file associated with a document identification, storing said received either the document image file or the document attribute file as indexed by the document identification, receiving subsequently one of the document image file and the document attribute file that is not stored, and associating said subsequently received one of the document image file and the document attribute file with said stored one of the document image file and the document attribute file based on the document identification.

19. The device according to claim 18, further comprising:
an intermediate storage storing said received either the document image file or the document attribute file as indexed by the document identification.

20. The device according to claim 18, wherein the merger transmits an attribute submission form description to a client in response to a request from the client, and receives attributes of the document attribute file from the client using the attribute submission form.

21. The device according to claim 20, wherein the merger transmits the attribute submission form description to the client over a network.

22. The device according to claim 20, wherein the attribute submission form description includes a list of previously scanned document image files associated with the client.

23. A computer program product embodied on a computer-readable medium, for entering documents into a digital back-end system, the computer program product comprising computer-executable instructions for:
receiving, over a communications network, a document identification with either a document image file or a document attribute file associated with a document identification;
storing said received either the document image file or the document attribute file as indexed by the document identification;
receiving subsequently, via a communications network, one of the document image file and the document attribute file that is not stored; and
associating said subsequently received one of the document image file and the document attribute file with said stored one of the document image file and the document attribute file based on the document identification.

24. The computer program product according to claim 23, further comprising computer-executable instructions for:
generating and transmitting an attribute submission form description to a client in response to a request from the client, so as to receive attributes of the document attribute file.

25. The computer program product according to claim 24, wherein the attribute submission form description includes a list of previously scanned document image files associated with the client.
